(19) United States
(12) Patent Application Publication
(10) Pub. No.: US 2011/0282642 A1
(43) Pub. Date: Nov. 17, 2011

(54) NETWORK EMULATION IN MANUAL AND AUTOMATED TESTING TOOLS

(75) Inventors: Lonny B. Kruger, Wake Forest, NC (US); William H. Barnett, Chapel Hill, NC (US); Edward D. Glas, Raleigh, NC (US); Michael W. Taute, Raleigh, NC (US)

(73) Assignee: MICROSOFT CORPORATION, Redmond, WA (US)

(21) Appl. No.: 12/780,896

(22) Filed: May 15, 2010

(51) Int. Cl. G06F 9/455

(52) U.S. Cl. 703/27

(57) ABSTRACT

A network emulation system is described herein that allows a software developer to accurately simulate different network characteristics while testing an application, framework, or other software code on a single or multiple computers. The system also provides an ability to record a real network's characteristics and apply those characteristics during a test. The network emulation system integrates a network emulation facility into test tools for both manual and automated tests and allows an application, framework, or other software code to be tested while operating under varying networking conditions such as bandwidth, latency, packet reordering and duplication, disconnection, and so forth. Thus, the network emulation system allows a software developer testing software code to quickly and easily determine how the software code will perform in a variety of real-world networking situations without physically setting up each of those situations.

### BACKGROUND

Modern software typically involves many components often developed by large teams of software developers. The days of procedural programming in which a single developer could write an application that simply executed from start to finish performing a single, well-defined task are gone. A software developer often uses libraries, components, frameworks, and other bodies of code written by other developers, producing software code that interacts with other systems and operates in a well-connected environment. The chances for mistakes or misunderstanding how to use a particular external function or module are higher than ever.

Most software today also involves the use of one or more networks. The rise of the Internet and corporate local area networks (LANs) has led to most applications including at least some network-based functionality. Applications may access public Internet data, private data stored on a corporate LAN, databases (remote, local, or cloud-based), and many other network-based resources.

Application testing and verification usually involves using software in a variety of real-world conditions to ensure that the software behaves correctly. Software testers often develop comprehensive suites of test passes that each verify that the software provides an expected response under one or more conditions. The conditions may include normal conditions as well as edge cases, input that should be recognized as invalid, and so forth.

Testing applications under different networking conditions can be difficult. It is hard to predict how an application will behave when faced with a loss of network connectivity or when networking conditions are different from what is expected. Accurately simulating these conditions often involves expensive hardware, running the test multiple times or manual user intervention. For example, consider a large internet e-commerce site. When updating the web application and other software that runs the e-commerce site, the site owner would prefer to test real-world loads against the system. However, the site may typically experience 50,000 or more customer purchases per day. The software manufacturer would have a hard time setting up 50,000 machines to produce the kind of real world loads that the software will experience every day. In addition, the site owner may want to prepare for peak loads, such as orders on Valentine's Day or other holidays when the e-commerce site typically experiences higher than average usage.

### SUMMARY

A network emulation system is described herein that allows a software developer to accurately simulate different network characteristics while testing an application, framework, or other software code on a single or multiple computers. The system also provides an ability to record a real network's characteristics and apply those characteristics during a test. The network emulation system integrates a network emulation facility into test tools for both manual and automated tests and allows an application, framework, or other software code to be tested while operating under varying networking conditions such as bandwidth, latency, packet reordering and duplication, disconnection, and so forth. The system accurately simulates multiple networks for software code that is being tested individually or under load using a single or multiple computers. Thus, the network emulation system allows a software developer testing software code to quickly and easily determine how the software code will perform in a variety of real-world networking situations without physically setting up each of those situations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the network emulation system, in one embodiment.

FIG. 2 is a flow diagram that illustrates processing of the network emulation system to record characteristics of a network, in one embodiment.

FIG. 3 is a flow diagram that illustrates processing of the network emulation system to setup and perform a load test using simulated network hardware, in one embodiment.

FIG. 4 is a network packet diagram that illustrates a packet pair test for measuring network characteristics, in one embodiment.

FIG. 5 is a network packet diagram that illustrates a simple loss test for measuring network characteristics, in one embodiment.

FIG. 6 is a network packet diagram that illustrates a path chirp test for measuring network characteristics, in one embodiment.

FIG. 7 is a network packet diagram that illustrates a synchronized ping test for measuring network characteristics, in one embodiment.

FIG. 8 is a network packet diagram that illustrates a TCP window size test for measuring network characteristics, in one embodiment.

FIG. 9 is a network packet diagram that illustrates a TCP flood test for measuring network characteristics, in one embodiment.

### DETAILED DESCRIPTION

A network emulation system is described herein that allows a software developer to accurately simulate different network characteristics while testing an application, framework, or other software code on a single or multiple computers. For example, the system allows simulation of network load anticipated from thousands of computers using only a handful of computers. The system also provides an ability to “record” a real network's characteristics and apply those characteristics during a test. For example, a software developer may record different profiles for a Wi-Fi network, a Bluetooth network, a 3G cellular network, and so forth. Alternatively or additionally, the software developer may record profiles for networks with high packet loss (e.g., 10%), normal packet loss (e.g., <1%), high bandwidth, low bandwidth, high latency, low latency, and combinations of the same. The system provides the software developer with an ability to simulate multiple networks (e.g., 56 k, T1, T3) during the same test to simulate different potential usage patterns.

The network emulation system integrates a network emulation facility into test tools for both manual and automated tests and allows an application, framework, or other software code to be tested while operating under varying networking conditions such as bandwidth, latency, packet reordering and duplication, disconnection, and so forth. The system automatically generates a network profile of a real network by recording the characteristics of that network. The system later applies the network profile to a running test so that the software code is tested under the specified network conditions. The system accurately simulates multiple networks for software code that is being tested individually or under load using a single or multiple computers. Thus, the network emulation system allows a software developer testing software code to quickly and easily determine how the software code will perform in a variety of real-world networking situations without physically setting up each of those situations.

In some embodiments, a network emulation tool implementing the system tests applications, frameworks, or other software code using a single computer to simulate conditions of different network characteristics. Previously, this was done by buying additional hardware to reproduce different networking conditions. However, with the network emulation system a single computer can typically reproduce any network condition to be tested.

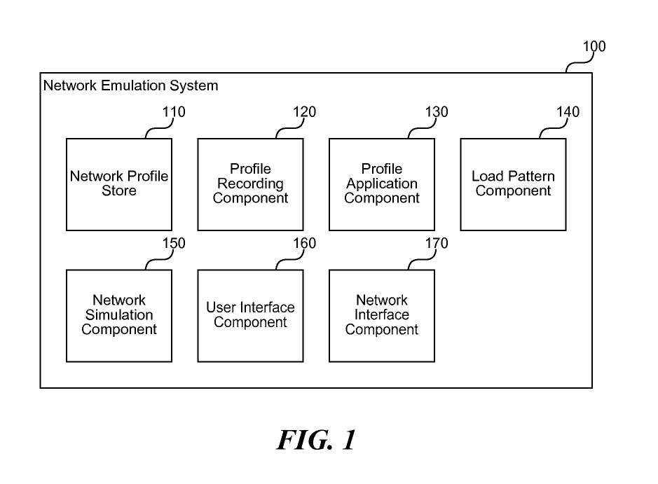

FIG. 1 is a block diagram that illustrates components of the network emulation system, in one embodiment. The system 100 includes a network profile store 110, a profile recording component 120, a profile application component 130, a load pattern component 140, a network simulation component 150, user interface component 160, and a network interface component 170. Each of these components is described in further detail herein.

The network profile store 110 stores network profiles that describe attributes of one or more networks that the system can emulate. The store may include one or more files, file systems, databases, cloud-based storage services, or other facility for storing information. The network profile store 110 stores a variety of network attributes including round-trip time across the network (latency), the amount of available bandwidth, queuing behavior, packet loss, reordering of packets, and error propagations. This information can be applied to upstream or downstream traffic or both. It can also be used to specify events such as packet reordering/loss and connectivity disconnections. Additionally, the profile stores how to apply the characteristics described in the profile.

The profile recording component 120 observes a particular network and records one or more attributes in a network profile stored in the network profile store 110. The component 120 is designed to easily record various characteristics, including round-trip time across the network (latency), the amount of available bandwidth, queuing behavior, packet loss, reordering of packets, and error propagations, of an existing network. The component 120 provides functionality to measure and record network capacity, available bandwidth, round trip time, packet loss rate, TCP throughput, and so forth. The recorded information is then saved in a network profile so that it can be used later by (for example) the network simulation component 150.

The profile recording component 120 may include a variety of tests and methods to determine characteristics of a particular network. Following are several examples. A packet pair bandwidth test sends back-to-back packets from a source to a destination and measures the pair's dispersion. From the size of the packets and the distance between them, the component 120 can approximate the capacity of a link with virtually no bandwidth impact. A simple loss test sends a specified number of packets and graphs the order in which they arrive, providing loss and reorder statistics. A ping test emulates the Internet Control Message Protocol (ICMP) ping using UDP sockets, providing a general round trip time (RTT) for the given link. A path chirp test uses an exponential flight pattern of probes called a chirp. By rapidly increasing the probing rate within each chirp, the test obtains a rich set of information from which to dynamically estimate the available bandwidth. A Transmission Control Protocol (TCP) window size test tracks the growing and shrinking of the TCP window size by repeatedly filling the socket buffer until it becomes full. A TCP flood test sends as much traffic as possible through a single TCP connection in a specified span of time (e.g., one second). The profile recording component 120 uses these and other tests to identify and record attributes of a given network connection between two or more endpoints.

The profile application component 130 receives an indication of an identified profile from a user or test harness, and loads information related to the profile from the network profile store 110. In some embodiments, the user indicates to the test framework that they wish to simulate a particular network by enabling the network emulation functionality. The user then selects a profile from a configuration dialog indicating which characteristics they would like to simulate. For example, the user may select an 801.11b Wi-Fi profile. When the test run starts, the profile application component 130 configures the network simulation component 150 and starts network emulation as specified in the profile. When the run finishes, network emulation is stopped and all simulation is stopped.

The load pattern component 140 receives multiple network profiles to include in a mix of network traffic for testing software code. When creating a load test, a user specifies a set of scenarios to run. Each scenario includes a set of tests and a set of virtual users. The user also specifies a “network mix.” This network mix is a set of network profiles to assign to virtual users. This will allow the test to simulate different users on different types of networks. For example: x number of users using a 56 KBPS phone modem, x number of users using a T1 line, and x number of users using a 3G cell phone. The network mix allows the user to specify different network profiles by percentage of users. For example, a user can specify a mix in which 50% of the users use a cable modem, 10% use a 56 kbps modem, and 40% use a T1 line. The user may also specify the total number of connections or users to test (e.g., 50,000), and the system will create virtual connections according to the selected load pattern.

The network simulation component 150 applies one or more selected network profiles at runtime to exhibit characteristics defined by the selected profiles during testing of software code. When a load or other test starts, network emulation starts. The network simulation component 150 takes an inventory of all of the available TCP/IP ports. The component 150 then divides these ports up into x sets of ports (x=number of scenarios) and assigns each scenario a set of ports where each set gets a number of ports proportional to the number of virtual users in that scenario. Each scenario then divides its set of ports into n sets (n=number of profiles specified in the network mix) where each set gets a number of ports proportional to a distribution of the profiles. All network traffic generated from each virtual user is then directed to the appropriate port based upon which network profile that user was assigned. In some embodiments, the network simulation component 150 and other components are provided as an extension or built-in feature of an integrated development environment (IDE), such as MICROSOFT™ Visual Studio. This allows software developers to write software code and then setup network-based testing of the code in the same environment.

The user interface component 160 provides an interface to one or more users for configuring and instantiating network testing using the system. For example, the user interface may provide one or more configuration dialogs through which a user can select a particular network profile or a mix of network profiles to use for a test run. In some embodiments, the user interface component 160 provides an application programming interface (API) through which a test application can programmatically configure the system 100 to achieve a particular mix of networking characteristics and connections for a particular test.

The network interface component 170 provides an interface to one or more network hardware devices. In some cases, the network interface component 170 may include a protocol driver or other operating system extension that provides other components of the system 100 with low-level access for manipulating packets stored and transferred through an operating system network stack. The extension also allows the component 170 to modify source and destination addresses, discard packets that are marked to be lost (e.g., for simulating packet loss), holding packets that are marked for reordering or delay, and so forth. The network interface component 170 may interface with physical network hardware as well as a virtual loopback adapter that allows simulation of network connections that take place entirely on a single machine.

The computing device on which the network emulation system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

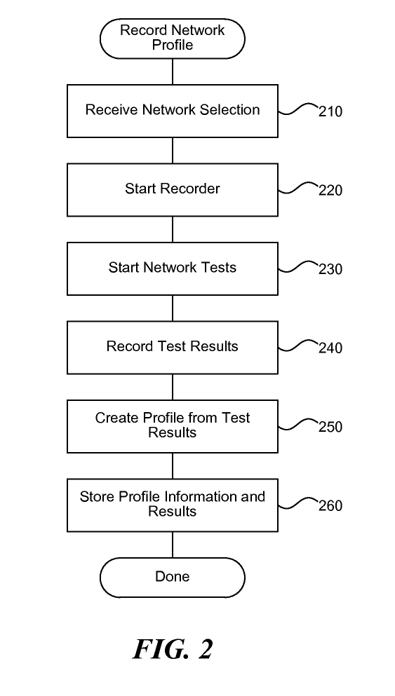

FIG. 2 is a flow diagram that illustrates processing of the network emulation system to record characteristics of a network, in one embodiment. Beginning in block 210, the system receives information identifying a physical network. For example, a user may specify that the connection from a current computer system to an identified remote computer system be measured by identifying the remote computer system. The user may specify an IP address, domain name system (DNS) name, and so forth to identify the remote computer system. Continuing in block 220, the system starts a network recording tool to determine characteristics of the network. For example, the tool may invoke one or more network tests designed to determine a network's bandwidth, latency, buffering, and other characteristics.

Continuing in block 230, the system starts one or more network measurement tests selected to measure characteristics of the identified physical network. For example, the system may start a suite of tests that includes a ping test, packet pair test, and other tests that produce results useful for determining the characteristics of a network. The determined characteristics may include bandwidth, latency, packet loss, and so forth. Continuing in block 240, the system captures one or more tests results and analyzes the results to identify characteristics of the identified physical network. For example, the system may measure differences in the receipt time of packets in a packet pair test to determine latency and/or bandwidth of the physical network. The system may store the results in an intermediate buffer to allow multiple tests to complete before performing analysis or may analyze test results in parallel to speed up network measurement. Continuing in block 250, the system receives an indication that the one or more network measurement tests have completed and creates a network profile from the test results. For example, the system may invoke one or more threads for performing the tests and the threads may complete with an indication of the test results.

The system receives information describing the new profile. For example, the user may specify a name for the profile, descriptive text, and identification of known characteristics of the network (e.g., wireless connection, wired connection, 802.11b, 3G network, and so forth. The system uses the received information to identify the profile to the user later. For example, the system may present a list of friendly profile names to the user from which to select at the start of a test run. Continuing in block 260, the system stores the received information describing the profile and the analyzed test results in a stored network profile for subsequent use during testing of software code that uses networking. For example, the system may store the profile in a database or file (e.g., an extensible markup language (XML) file) with other network profiles from which tests can select. After block 260, these steps conclude.

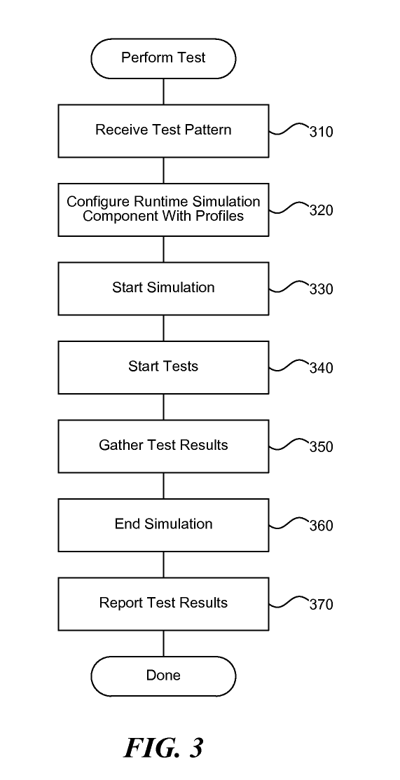

FIG. 3 is a flow diagram that illustrates processing of the network emulation system to setup and perform a test using simulated network hardware, in one embodiment. Beginning in block 310, the system receives one or more network profiles from a network profile store that comprise a test pattern and describe characteristics of one or more networks to emulate during the load test. For example, the system may present a user interface or API from which a user or test program receives a list of available network profiles, selects profiles to include in a load pattern for the load test, and specifies a network mix of the selected profiles (e.g., number of connections of each or percentage of a total number). The system may receive anything from applying characteristics to a single machine on which the test is running to simulating many additional computer systems connected via a network. Continuing in block 320, the system configures a runtime network simulation component with information related to the received one or more network profiles. The network simulation component may provide a variety of configurable inputs that the system can set as appropriate for each particular network profile. For example, the network simulation component may include settings for an average latency, average packet loss, bandwidth, and other common network attributes.

Continuing in block 330, the system starts simulating the received pattern based on the received network profiles. For example, the system may create one or more software threads and/or open one or more network ports for the selected mix of networking profiles. If the user selected a single connection, then the system may apply bandwidth and latency limitations specified by the network profile. If the user selected 50,000 connections, then the system may reserve a suitable number of ports to simulate behavior of each of 50,000 virtual users to test the subject software code under load. In some embodiments, the system may control other computer systems and may use other computer systems to provide part of the selected network mix. For example, a load test involving 20,000 connections may be conducted by assigning 10,000 connections to each of two remote computer systems.

Continuing in block 340, the system starts one or more tests specified by an application developer that test target software code under a load produced by the received load pattern. For example, the application developer of an e-commerce web application may include tests that order a particular item from an electronic catalog while the web application is occupied with thousands of requests to determine a responsiveness of the web application under load. Various tests can be provided by the application developer with the network emulation system providing a specified network load under which to perform the tests. Continuing in block 350, the system gathers results of the one or more tests. For example, the system may measure ordering time, responsiveness, success of an operation, or other criteria specified by the application developer as part of the test.

Continuing in block 360, after the one or more tests are complete, the system ends the network simulation. For example, the system may reconfigure a test machine's networking settings for normal network usage, unload one or more protocol drivers, and so forth to return the test machine to a pre-test state. Continuing in block 370, the system reports the gathered results of the one or more tests to the application developer. For example, the system may display a visual report, write results to a log file, provide results through an API, or any combination or other method of exporting test results. Based on the load test the application developer can determine how the application will behave under realistic network conditions without the time and expense of setting up a physical reproduction of a production network environment. After block 370, these steps conclude.

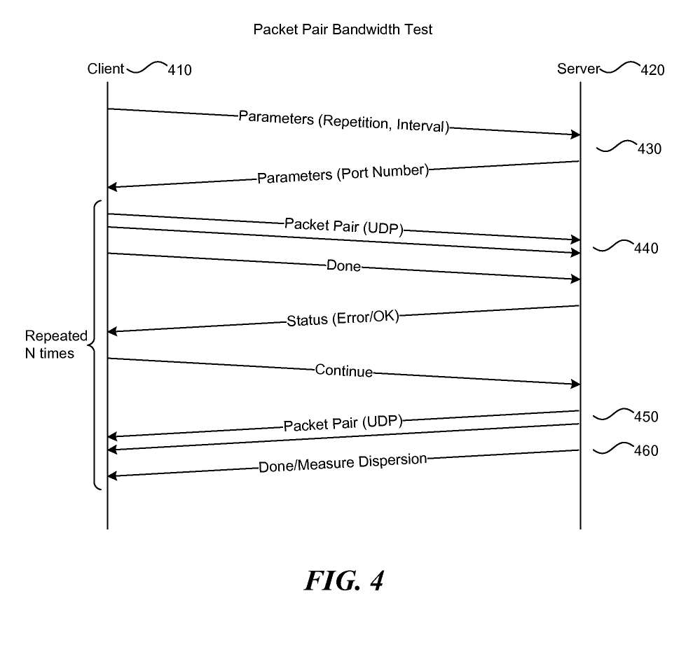

FIGS. 4-9 illustrate packet behavior for conducting one or more network measurement tests to measure the characteristics of a physical network. The network emulation system uses these and similar tests to create a network profile of a real network that can subsequently be used to simulate behavior of the real network in a test environment.

FIG. 4 is a network packet diagram that illustrates a packet pair test for measuring network characteristics, in one embodiment. The left line represents a client 410. The arrows leaving the left line represent packets sent by the client 410 and the arrows pointing at the left line indicate packets received by the client 410. The right line represents a server 420 with which the client 410 communicates. The terms client and server do not represent any specific type of computer hardware as a particular machine can at some times represent a client and at other times represent a server. Either machine could be a desktop computer, laptop, cell phone, or other type of computing device.

In the packet pair test, one or more setup packets 430 are exchanged between the client 410 and server 420 to configure the test. For example, the client might send the server a number of times to repeat the test and an interval the client 410 will use between packet pairs. The server 420 may respond with a port number assigned to the connection or other information. To begin the test, the client sends a pair 440 of Unreliable Datagram Protocol (UDP) packets to the server. The server may also send a similar pair 450 of packets to the client. After receiving the packets, the server 420 sends a result packet 460 to the client 410 that indicates a measured dispersion between the packet pair 440. The client 410 may also measure dispersion for pairs of packets received from the server 420. The process may repeat multiple times with each side sending a new pair of UDP packets and measuring the dispersion or other characteristics. Using this information, the client 410 determines characteristics of the link between the client 410 and server 420.

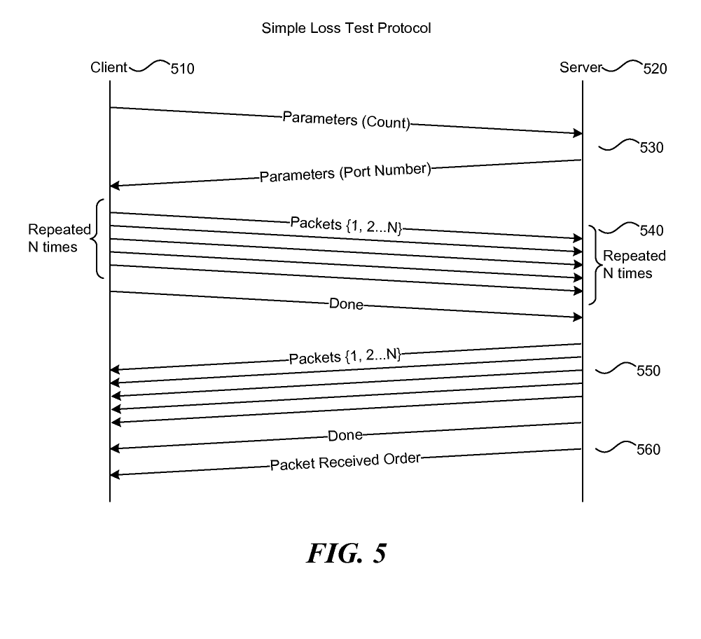

FIG. 5 is a network packet diagram that illustrates a simple loss test for measuring network characteristics, in one embodiment. The simple loss test includes a setup phase during which a client 510 sends one or more setup packets 530 to a server 520 to configure each side for the test. The simple loss test involves sending many packets 540 from the client 510 to the server 550. The server 520 may also send batches of packets 550 to the client 510. The server 520 indicates to the client 510 how many packets were received and optionally in what order through a result packet 560. Based on the information received from the server 520, the client 510 can determine a rate of packet loss, whether packet reordering or duplication is occurring, and other characteristics of the link between the client 510 and server 520.

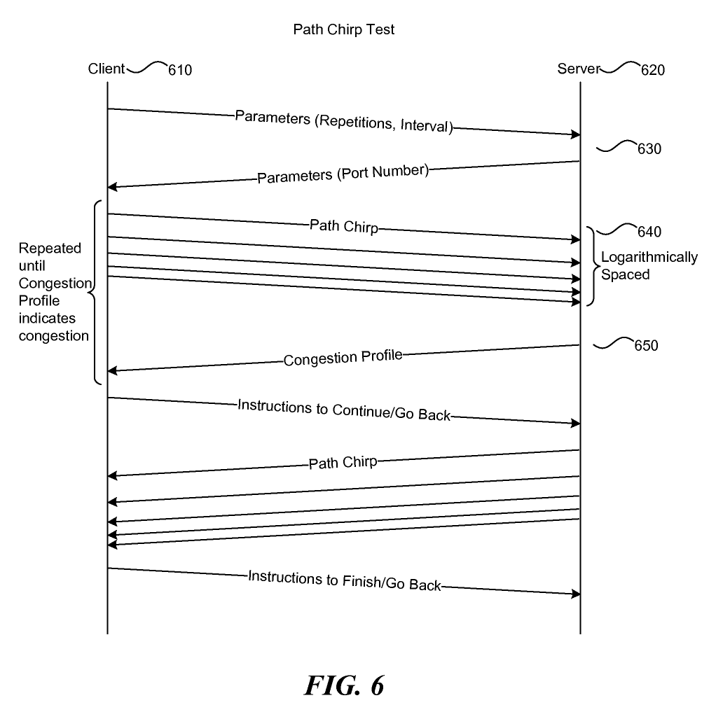

FIG. 6 is a network packet diagram that illustrates a path chirp test for measuring network characteristics, in one embodiment. The path chirp test includes a setup phase during which a client 610 sends one or more setup packets 630 to a server 620 to configure each side for the test. The path chirp test involves sending logarithmically spaced packets 640 from the client 610 to the server 650. The server 620 responds with a congestion profile packet 650 that indicates the information about the packets received by the server 620, such as when they arrived and in what order. The server 620 may also send batches of packets to the client 610, so that the client 610 can perform similar measurements for the return path. Based on the information received from the server 620, the client 610 can determine various characteristics of the link between the client 610 and server 620.

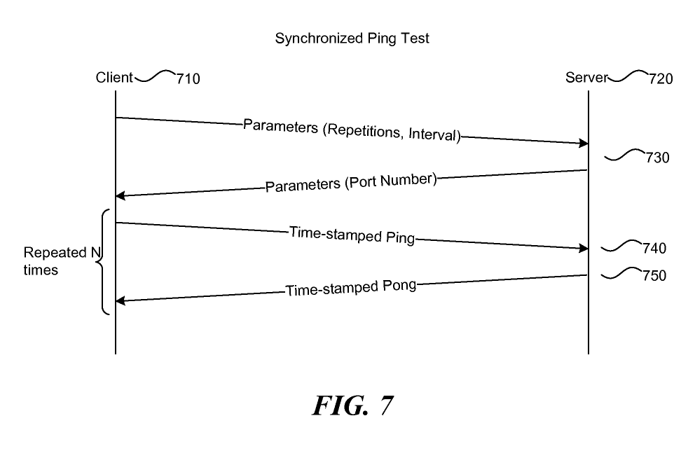

FIG. 7 is a network packet diagram that illustrates a synchronized ping test for measuring network characteristics, in one embodiment. The synchronized ping test includes a setup phase during which a client 710 sends one or more setup packets 730 to a server 720 to configure each side for the test. The synchronized ping test involves sending time-stamped ping packets (e.g., an ICMP ping) that can be used to measure round trip time and one-way latency from the client 710 to the server 720. The server 720 provides an acknowledgement 750 or pong that may also be time-stamped to allow the client to measure similar characteristics of the return path. Based on the information received from the server 720, the client 710 can determine various characteristics of the link between the client 710 and server 720.

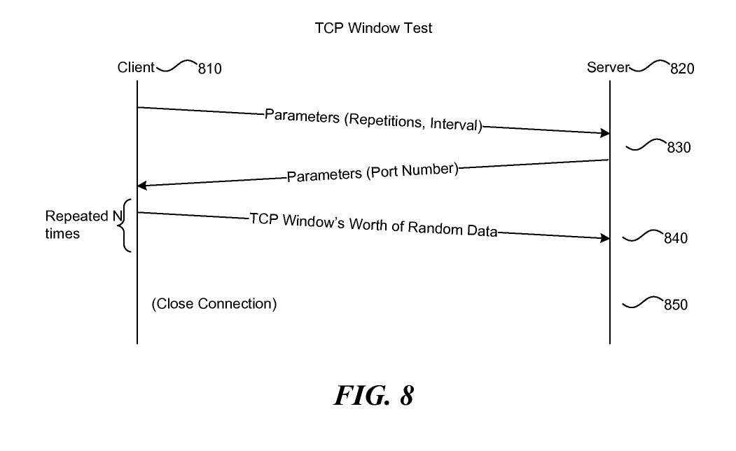

FIG. 8 is a network packet diagram that illustrates a TCP window size test for measuring network characteristics, in one embodiment. The TCP window size test includes a setup phase during which a client 810 sends one or more setup packets 830 to a server 820 to configure each side for the test. The TCP window size test tracks the growing and shrinking of the TCP window size by repeatedly filling the socket buffer until it becomes full. The client 810 sends a TCP window's worth of data 840 to the server and then closes the connection. By doing this repeatedly, the client 810 can fill any local client-side buffer and determine the TCP window size.

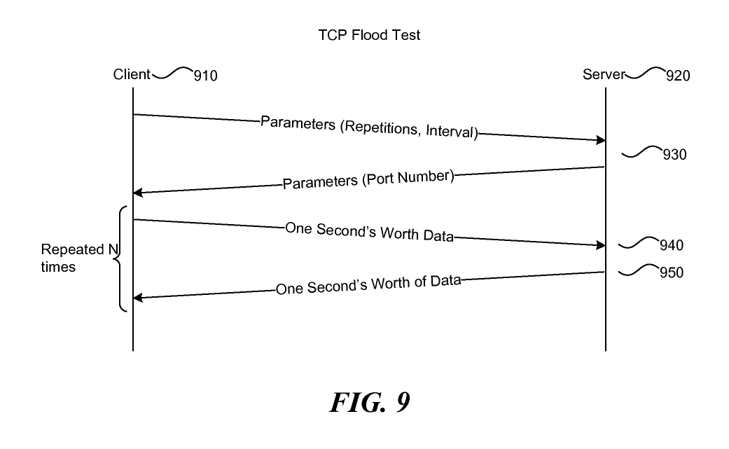

FIG. 9 is a network packet diagram that illustrates a TCP flood test for measuring network characteristics, in one embodiment. The TCP flood test includes a setup phase during which a client 910 sends one or more setup packets 930 to a server 920 to configure each side for the test. The TCP flood test sends as much traffic as possible through a single TCP connection in a specified span of time (e.g., one second). For example, the client 910 may send one second's worth of data in a packet 940 to the server 920, and the server 920 may respond by sending a similar packet 950 to the client 910. Based on the information received from the server 920, the client 910 can determine various characteristics of the link between the client 910 and server 920.

In some embodiments, the network emulation system combines network simulation with performance testing tools to generate unified results. For example, the system may report on the response time of a website under load from many network connections. As another example, an application developer may set thresholds, such as a threshold order time, so that the system alerts the developer at any time during testing when a threshold is exceeded (e.g., an order time over two minutes). The system may also alert the developer if any error state is produced, such as a Hypertext Transfer Protocol (HTTP) 500 response.

In some embodiments, the network emulation system creates new virtual users randomly based on a specified load pattern. For example, the system may create the total number of users at the outset and place them in categories related to the network profile with which they are associated. For example, if the user has selected 1,000 users and for 50% of the users to use one network profile, then the system creates 1,000 users and places 500 of them in the category associated with the correct profile. Then, during testing, the system may randomly select from the pool of available users and the distribution will match (on average) that of the specified load pattern.

In some embodiments, the network emulation system creates a session log per user, so that after any given test an application developer or other user can review the logs for a particular user to ensure the user's experience with the application meets quality standards. For example, the developer may review logs to determine whether any user experienced slow page load times, error messages, or other problems. The session log may include information about the network profile associated with the user, requests that were made, and timing of requests and responses.

In some embodiments, the network emulation system aggregates result data for multiple virtual users into a unified report or unified individual statistics. For example, for a web application the system may produce aggregate data about home page response time based on an average of all users, users associated a particular profile type, and other useful subdivisions.

In some embodiments, the network emulation system can be used for live testing with a real user. For example, an application developer providing a web-based application worldwide may want to run the application to experience what a user from Japan will experience, or what a user from across the country will experience. The system can provide a simulation based on a network profile selected by the real user, and then allow the user to manually interact with the application to determine if it behaves acceptably (e.g., responsive, no unusual delays, and so forth).

In some embodiments, the network emulation system can be used to apply a load to a system for purposes other than testing. For example, the system can be used to limit network capacity of a computer system, such as for enforcing bandwidth quotas. As an example, an administrator could setup a database server on a machine along with the network emulation package (it can be run in standalone mode as well as in an IDE) and have the network emulation package simulate a given network profile all the time. This could be a way of throttling all connections to that server. This could also be a way that a vender supplying a database in the cloud could limit certain customers to certain bandwidths.

From the foregoing, it will be appreciated that specific embodiments of the network emulation system have been described herein for purposes of illustration, but that various modifications may be made without deviating from the spirit and scope of the invention. Accordingly, the invention is not limited except as by the appended claims.

I/We claim:

1. A computer-implemented method for setting up and performing a test using simulated network hardware, the method comprising:
receiving one or more network profiles from a network profile store that comprise a test pattern and describe characteristics of one or more networks to emulate during the test;
configuring a runtime network simulation component with information related to the received one or more network profiles;
starting a simulation of the test pattern based on the received network profiles;
starting one or more tests that test target software code under network conditions produced by the received test pattern;
gathering results of the one or more tests;
after the one or more tests are complete, ending the network simulation; and
reporting the gathered results of the one or more tests to a user,
wherein the preceding steps are performed by at least one processor.

2. The method of claim 1 wherein receiving one or more network profiles comprises displaying a user interface from which a user can view a list of available network profiles, select profiles to include in a test pattern for the test, and specify a network mix of the selected profiles.

3. The method of claim 2 wherein the network mix includes a percentage of each type of network profile to include in the test pattern.

4. The method of claim 1 wherein receiving one or more network profiles comprises receiving a selection of one or more profiles via an application programming interface that provides programmatic access to a test application.

5. The method of claim 1 wherein configuring the runtime component comprises providing parameter values for at least one of an average latency, average packet loss, and bandwidth.

6. The method of claim 1 wherein starting a simulation comprises opening one or more network ports for the selected mix of networking profiles.

7. The method of claim 1 wherein starting a simulation comprises creating one or more virtual users each of which is connected to a software application with a connection having attributes matching one of the network profiles.

8. The method of claim 1 wherein starting a simulation comprises communicating with at least one remote computer system to prepare the remote computer system to provide at least part of the selected network mix.

9. The method of claim 1 wherein starting one or more tests comprises receiving an identification of code from a software application developer.

10. The method of claim 1 wherein ending the network simulation comprises. For reconfiguring a test machine's networking settings for normal network usage to return the test machine to a pre-test state.

11. The method of claim 1 wherein reporting the gathered results comprises producing a session log file for each of multiple virtual users defined by the test pattern.

12. A computer system for simulating network loads on an application, the system comprising:
a processor and memory configured to execute software instructions;
a network profile store configured to store network profiles that describe attributes of one or more networks that the system can emulate;
a profile recording component configured to measure a particular network and record one or more attributes in a network profile stored in the network profile store;
a profile application component configured to receive an indication of an identified profile and load information related to the profile from the network profile store;
a load pattern component configured to receive multiple network profiles to include in a mix of network traffic for testing software code;
a network simulation component configured to apply one or more selected network profiles at runtime to exhibit characteristics defined by the selected profiles during testing of software code;
a user interface component configured to provide an interface to one or more users for configuring and instantiating network testing using the system; and
a network interface component configured to provide an interface to one or more hardware or loopback network devices.

13. The system of claim 12 wherein the profile recording component is further configured to determine at least one of round-trip time across the network, an amount of available bandwidth, queuing behavior, packet loss, reordering of packets, and error propagations.

14. The system of claim 12 wherein the profile recording component is further configured to include one or more measurement tests that send and receive test loads to determine characteristics of the network.

15. The system of claim 12 wherein the profile application component is further configured to display a profile configuration dialog that receives one or more network profiles to simulate.

16. The system of claim 12 wherein the load pattern component is further configured to create a number of virtual users each associated with a network profile specified by the received network mix.

17. The system of claim 12 wherein the network simulation component is further configured to expose network simulation functionality in an integrated development environment application to allow a software developer to write software code and set up network-based testing of the code in the same environment.

18. A computer-readable storage medium comprising instructions for controlling a computer system to record characteristics of a network wherein the instructions, upon execution, cause a processor to perform actions comprising:
receiving information identifying a physical network;
starting to determine characteristics of the network;
starting one or more network measurement tests selected to measure characteristics of the identified physical network;
capturing one or more tests results and analyzing the results to identify characteristics of the identified physical network;
receiving an indication that the one or more network measurement tests have completed and creating a network profile that describes the measured characteristics of the network; and
storing the received information describing the network profile and the analyzed test results in a stored network profile for subsequent use during testing of software code that uses networking.

19. The medium of claim 18 wherein receiving information identifying a physical network comprises receiving information identifying two endpoints on the network and wherein the new network profile describes a connection between the identified two endpoints.

20. The medium of claim 18 wherein analyzing the results comprises measuring differences in the receipt time of packets to determine latency or bandwidth of the physical network.
